(19) United States
(12) Patent Application Publication
(10) Pub. No.: US 2004/0103538 A1
(43) Pub. Date: Jun. 3, 2004

(54) Razor cartridge

(75) Inventors: Paul R. Dansreau, Shelton, CT (US); Paul D. Richard, Shelton, CT (US); Mark S. Peyser, Easton, CT (US)

Correspondence Address: Richard R. Michaud, McCormick, Paulding & Huber LLP, CityPlace II, 185 Asylum Street, Hartford, CT, 06103, US

(73) Assignee: Eveready Battery Company, Inc., Westlake, OH

(21) Appl. No.: 10/643,495

(22) Filed: Aug. 19, 2003

Related U.S. Application Data
(60) Provisional application No. 60/405,259, filed on Aug. 21, 2002.

(51) Int. Cl. B26B 19/42

(52) U.S. Cl. 30/34.2; 30/50; 30/77

(57) ABSTRACT

A razor blade cartridge has a movable guide unit including a spacer and a plurality of fingers shaped and sized so that when the guide unit moves frontward between a leading blade and a following blade spaced rearward from the leading blade, the fingers engage skin flowing into space between the leading and following blades to decrease contact between the skin and the cutting edge of the following blade.

### CROSS-REFERENCE TO RELATED APPLICATIONS

This application is entitled to the benefit of and incorporates by reference essential subject matter disclosed in Provisional Patent Application No. 60/405,259 filed on Aug. 21, 2002.

### FIELD OF THE INVENTION

The invention relates to a multi-blade razor cartridge. Particularly, the invention relates to a multi-blade razor cartridge having a displaceable guide for controlling skin flow during a shaving stroke and provided with means for controllably locking the guide in a desired position.

### BACKGROUND OF THE INVENTION

The use of a multi-blade razor cartridge in a variety of shaving devices, such as a wet razor, is common due to desired blade geometry. Particularly, a multi-blade razor cartridge includes at least two blades providing leading and at least one following cutting edges, respectively, which successfully cut the hair during a single shaving stroke.

To achieve a shave that yields an acceptable level of shaving closeness to the user, traditional single-blade or multi-blade razor cartridges rely on contact between the skin and the cutting edge(s) of the blade(s). In a multi-blade razor cartridge, a seat functioning as the base of the cartridge and a cap coupled to the seat establish a shave plane, which is a plane tangent thereto. Once the shave plane is formed, leading and following cutting edges of multiple blades are positioned relative to the plane. If the skin flew only in the shave plane, it would be difficult to achieve a satisfactory shave because contact between the skin and the cutting edges is not sufficiently dose to allow the cutting edges to effectively cut the hair. Accordingly, based on cartridge geometry, skin can push past the shave plane before each of the cutting edges makes contact with it. However, as the skin moves beyond the shave plane and the angle of contact between the skin and the cutting edges gets increasingly larger, the user's skin becomes more susceptible to nicks, cuts and irritation.

Furthermore, during shaving with a multi-blade razor cartridge, various forms of debris, e.g., cut whiskers, shaving aids, etc., can lodge within the space between the blades. Accumulation of such shaving debris can detract from the effectiveness of the shave.

Among numerous approaches facilitating shaving with an increase in comfort to the user without compromising the acceptable level of cutting contact, the following four are common and include:

Improving cartridge geometry including modified blade spans and their exposures;

Wrapping a thin wire guard over the blades to serve as a protective barrier;

Wrapping a thin film over the blades to act as a protective barrier similar to a thin wire guard; and

Providing protrusions on a spacer located between the blades to control skin movement.

A multi-blade razor cartridge provided with a spacer has been introduced into the commercial market. The spacer is primarily used as a deaning device for removing shaving debris accumulated in the spaces between multiple blades.

For example, U.S. Pat. No. 5,377,409, which is fully incorporated herein by reference and is assigned to the assignee of the present invention, discloses a multi-blade unit having a spacer which is displaceable transverse to a shave plane in response to an external force to effectively remove the accumulated shaving debris.

While a spacer disclosed in U.S. Pat. No. 5,377,409 effectively deans the shaving debris, it cannot prevent skin from uncontrollable penetration into the spaces between the blades during a shaving stroke. This is because the spacer has a flat front edge extending parallel to the cutting edges and spaced rearward therefrom at a substantial distance during a shaving stroke, so that the front edge of the spacer cannot block the skin from moving deeply into the space between the blades.

U.S. Pat. No. 4,272,885, which is commonly owned by the assignee of this invention and the contents of which are incorporated by reference herein, discloses a multi-blade cartridge with a spacer that has a multiplicity of rounded projections located between the leading and following cutting edges of the blades. The projections lie on a shave plane and are designed to prevent skin from pushing into the space between the blades. However, the spacer, as disclosed in this patent, is positioned in a fixed spacial relationship with respect to the shave plane. Accordingly, since the position of the spacer cannot be adjusted to accommodate individual shaving profiles of at least some of the users, the cartridge with the fixedly positioned projections cannot bring an increase in comfort to these users during a shaving stroke.

U.S. Pat. No. 3,972,114 discloses a multi-blade cartridge provided with a cleaning mechanism which includes a spacer having a series of spaced protrusions. The protrusions are located between the leading and following cutting edges of adjacent blades so that as the spacer moves parallel to a shave plane, shaving debris are forced out of space defined by the spaced blades. Accordingly, if one experiences discomfort during a shaving stroke, one cannot displace the protrusions toward or away from the shave plane to control skin movement around the blades.

Furthermore, a laterally movable spacer cannot provide effective cleaning of shaving debris for the following reasons. First, there are strict limitations imposed on the number of protrusions and their shapes. The protrusions have to extend at a certain angle to a direction of displacement of the spacer that can allow diverging lateral sides of adjacent protrusions to push the debris out of the space. Manufacture of protrusions having this angle leads to a time consuming and rather expensive manufacturing process. Second, lateral displacement of the spacer is limited due to the requirements imposed on the overall size of a cartridge, which should be relatively small. However, the smaller the lateral stroke, the less effective the cleaning.

The above discussion of the known prior art illustrates that while the shaving industry recognized a problem associated with uncontrollable skin engagement between adjacent blades, it still continues to balance closeness with comfort.

It is, therefore, desirable to provide a multi-blade cartridge having a guide unit for controlling skin flow. A multi-blade cartridge provided with an effective cleaning unit is also desirable.

### SUMMARY OF THE INVENTION

The above objects are attained by a multi-blade cartridge provided with a guide unit for controlling skin flow during a shaving stroke. In particular, the guide unit includes a spacer provided with a series of spaced fingers. The spacer is mounted between leading and cutting edges of a base blade and a following cap blade, respectively, so that when an external force is applied to the spacer, the entire guide unit can move from an initial position in which the spaced apart fingers can be spaced below a shave plane to multiple working position in which the fingers lie on or beyond the shave plane. The shave plane referred herein is a plane tangent to and defined between a seat and a cap of a cartridge.

In accordance with an aspect of this invention, a multi-blade cartridge has a guard bar provided with fixed protective members which control skin flow before contact is established between the skin and a cutting edge of the leading blade. The protective members can be dimensioned and shaped so that they can terminate below, on or above the shave plane.

According to another aspect of the invention, a cap of the multi-blade cartridge has protrusions extending toward a cutting edge of the last blade substantially in the shave blade. The protrusions are shaped and dimensioned to further improve skin flow by guiding the skin so it slides without injury over the cap. As a result, the protrusions minimize penetration of skin into the space between a cap blade and the cap, which, otherwise, can reduce comfort of the user during a shaving stroke.

In accordance with still another aspect of the invention, the guide unit can be displaced beyond the shave plane in response to an external force and, when the external force is removed, the guide unit returns to its original positions. Thus, the guide unit integrates skin flow control with a cleaning unit that has dynamic action for debris removal.

In accordance with still another aspect of the present invention, the guide unit can be locked in any of its positions. Thus, the user can establish and maintain a position of the guide unit in which shaving contact between the cutting edges and the skin is controllably reduced. Accordingly, the user can shave with an increase in comfort without sacrifice of shaving closeness.

### BRIEF DESCRIPTION OF THE DRAWINGS

The above and other objects, features and advantages will become more readily apparent from the following description taken in conjunction with the accompanying drawings, in which:

FIG. 1 is an isometric view of a multi-blade cartridge;

FIG. 2 is a sectional view of a guide unit taken along lines A-A of FIG. 1;

FIG. 3 is a front elevational view of the multi-blade cartridge shown mounted on a handle;

FIG. 4 is a cross sectional view of the multi-blade cartridge taken along lines B-B of FIG. 3; and

FIG. 5 is a sectional view of a protective member provided on a guard bar of the multi-blade cartridge taken along lines C-C of FIG. 1.

### DETAILED DESCRIPTION OF THE PREFERRED EMBODIMENTS

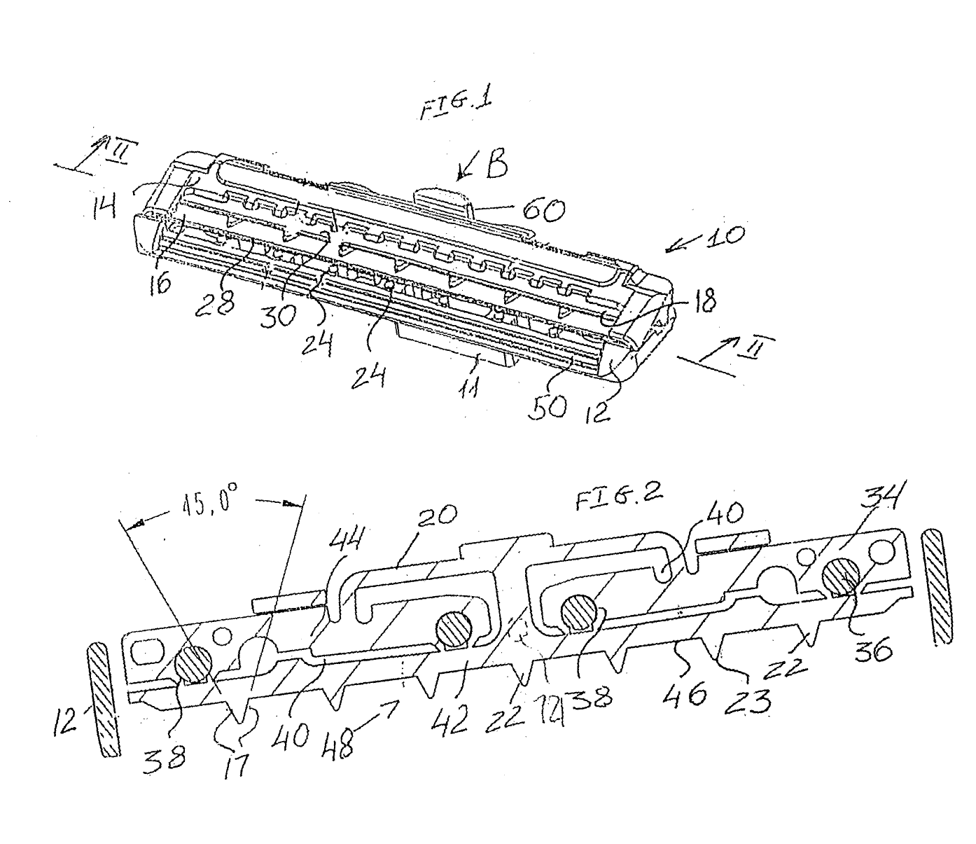

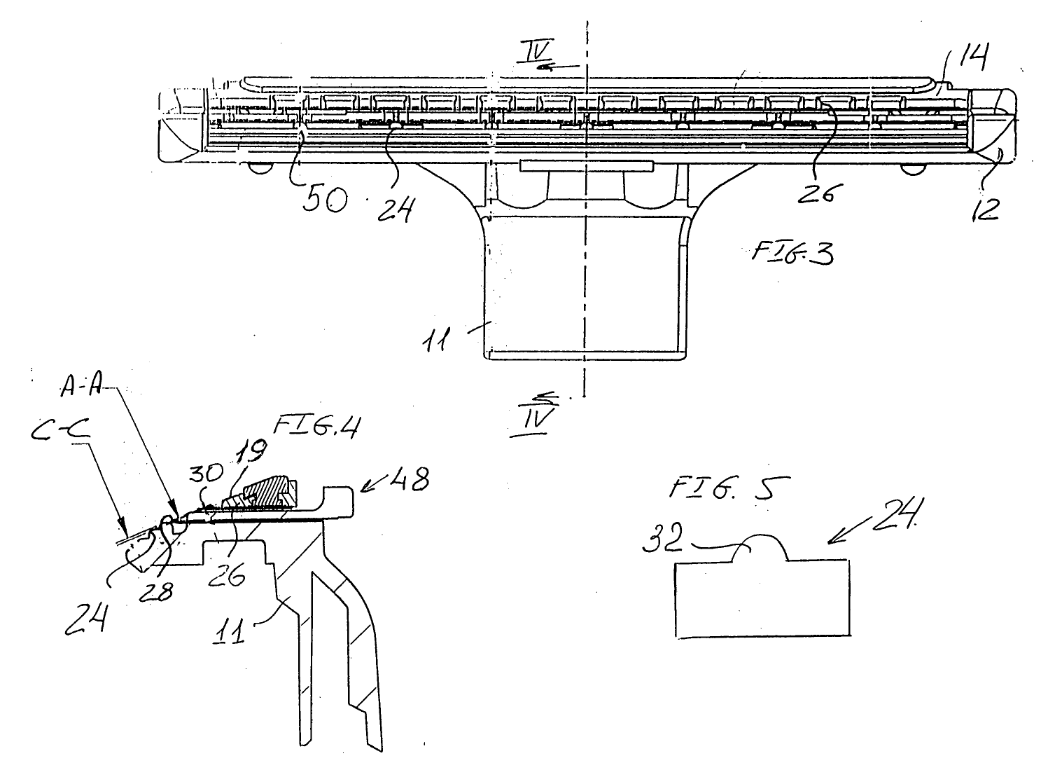

Referring to FIGS. 1, 2, 3 and 4, a multi-blade cartridge 10, including two or more blades, is attached to a handle 11 and is assembled of a seat 12, a cap 14, a pair of seat 16 and cap 18 blades. The seat blade 16 having a leading cutting edge 28 and the cap blade 18 blade provided with a trailing cutting edge 30, which is spaced rearward from the leading cutting edge 28, are spaced apart and define space therebetween. As skin flows from a shave plane A-A (FIG. 4), which is tangent to the seat 12 and the cap 14, it tends to project over this plane and penetrate into the space between the seat blade 16 and the cap blade 18. The portion of skin protruding between the blades 16 and 18 may get nicked or cut To minimize the extent of penetration, the multi-blade razor cartridge 10 has a guide unit 48 (FIGS. 2 and 4) for controlling skin flow, which guide unit is mounted between the blades 16 and 18 blades to at least partially fill the space between these blades

Referring specifically to FIG. 2 showing a section of the guide unit 48, which is taken along lines II-II of FIG. 1, the guide unit 19 includes a spacer 20 and a plurality of spaced apart fingers 22 extending from the spacer 20. The fingers 22 can have various shapes and sizes and can be, at least at least partially, retracted under the cap blade 18 to allow contact between the skin and the following cutting edge 30 of the cap blade. Preferably, each finger 22 has opposite sides 17 converging toward one another to form a respective pointed tip 23.

The spacer 20 is made from flexible material which permits limited transverse movement of the seat 12 and cap 14 relative to one another as the multi-blade cartridge 10 flexes to conform to the natural contour of the surface being shaved. A body 34 of the spacer 20 has a plurality of holes 38 sized to engage posts 36 which couple the seat 12, the cap 14 the blades 16, 18 and the guide unit 48 together. As a result of engagement between the posts 36 and the peripheries of the holes 38, the body 34 has a rear stabilized assembly section 44 which remains immovable in response to an applied external force, as indicated by arrow B (FIG. 1), and thus maintains a fixed spatial relationship between the seat 16 and cap 18 blades. In addition, the body 34 has a plurality of differently shaped and sized recesses 40 defining a front segment 42 which moves in a direction perpendicular to the cutting edges in response to the applied external force. As a result of this movement, the front segment 42 has a double function: first, it guides skin flow, and second, it ejects shaving debris accumulated in the space between the blades as an edge 46 of the front segment 42 advances beyond the shave plane A-A.

A specific number of the fingers 22 as well as a distance, at which adjacent fingers can be spaced apart, varies. An initial position of the front segment 42 of the spacer 20 is selected so that the tips 23 of the fingers 22 are spaced rearward from the leading cutting edge 28 of the seat blade 16 to allow skin to flow beyond the shave plane A-A. If the front segment 42 is spaced far away from the shave plane, the skin flows deeply into space before it contacts the fingers 22 and may cause discomfort to the user. To avoid it, the user can control skin flow by applying a force as indicated by arrow B (FIG. 1) to an actuator 60 displacing the front segment 42 of the spacer 20 toward the shave plane A-A. A desired working position of the spacer 20 will be reached when the user feels comfortable. In the desired working position, the tips 23 of the fingers 22 can extend toward and beyond the shave plane A-A without substantially affecting a shaving contact between the skin and the following cutting edge 30 of the cap blade 18. Indeed, a substantial amount of skin defined between the spaced apart fingers 22 will flow beyond the shave plane A-A and create an acceptable level of shaving contact.

To remove shaving debris from space defined between the following cutting edge 30 of the cap blade 18 and the front edge 46 of the spacer 20, the user applies the force B sufficient to displace the front edge 46 beyond the shave plane A-A. As the front edge 46 moves toward and beyond the shave plane A-A, it dislodges the shaving debris outward from the space formed between the blades 16, 18, which displaced debris can be later washed away.

The seat 12 is provided with a guard bar 50 positioned immediately below the seat blade 16 and having fixed members 24 for guiding skin flow toward the leading cutting edge 28 of the seat blade 16. The size of the fixed members 24 can vary so that their top portions 32 (FIG. 5) can terminate below, in or above the shave plane A-A.

Preferably, the top portions 32 are rounded and extend slightly above the shave plane. The fixed members 24 are spaced apart at any desired distance. However, like the distance between the fingers 22 of the spacer 20, the fixed members 24 are spaced at a distance allowing a substantial amount of skin flow slightly beyond the shave plane A-A. The fixed members 24 and the fingers 22 can be aligned in a direction parallel to skin flow which, in turn, is perpendicular to the longitudinal extent of the cutting edges 28, 30. Alternatively, the fixed members 24 and fingers 22 can be staggered with respect to one another to define different points of contact between the skin and the fingers 22 and the skin and fixed members 24. Therefore, a combination of the guide unit 48 and the fixed members 24 provide the user with an increase in comfort and while still establishing an acceptable level of shaving contact.

Based on individual preferences, the spacer can move in different positions with respect to the shave plane and thus provide maximum comfort. To register the spacer 20 in the most individually comfortable working position, the body 34 of the spacer 20 has a means for engaging, such as at least one protrusion 63, as diagrammatically shown in FIG. 2, mating with a series of spaced indentations (not shown), which are provided in the seat 12 and extend along a travel direction coinciding with the arrow B.

The embodiments of the invention, which have been described above, are merely illustrative of a few of the applications of the principles of the invention. Various modifications may be made by an artisan without departing from the scope of the invention, as recited by the following claims.

What is claimed is:

1. A razor blade cartridge comprising:
a seat;
a cap mounted on the seat so that the seat and the cap define a space therebetween;
at least one blade having a cutting edge and mounted between the seat and the cap; and
a spacer coextensive with the at least one blade and mounted between the seat and the at least one blade, the spacer having a plurality of spaced apart fingers extending frontward of the spacer and being operable between an initial position wherein the fingers are retracted rearward of the cutting edge and a plurality of working positions wherein the fingers are displaced toward and beyond the cutting edge for controllably decreasing contact between the cutting edge of the at least one blade and the skin and for removing shaving debris accumulated in the space.

2. The razor blade cartridge as claimed in claim 1, further comprising a seat blade mounted between the seat and the spacer and having a cutting edge spaced frontward of the cutting edge of the at least one blade, a plane tangent to the seat and cap being a shave plane.

3. The razor blade cartridge as claimed in claim 2, wherein the fingers of the spacer are spaced below the shaving plane in the initial position of the spacer.

4. The razor blade cartridge as claimed in claim 2, wherein the fingers of the spacer lie in or beyond the shave plane in the plurality of the working positions.

5. The razor blade cartridge as claimed in claim 2, wherein the seat has a guide bar coextending with the cutting edges of the at least one and additional blades and having a plurality of fixed members which are spaced apart along the guard bar and extend upward therefrom, each of the fixed members having a respective rounded top terminating below, on or above the shave plane.

6. The razor blade cartridge as claimed in claim 5, wherein the fixed members provided on the seat are aligned with the fingers formed on the spacer in a direction perpendicular to a longitudinal extent of the cutting edges of the at least one and seat blades.

7. The razor blade cartridge as claimed in claim 5, wherein the fixed members and the fingers alternate in a direction parallel to a longitudinal extent of the cutting edges of the at least one and additional blades.

8. The razor blade cartridge as claimed in claim 1, wherein the spacer has a continuous front edge from which the fingers extend frontward, at least one of the plurality of working positions wherein the front edge of the spacer lies in or beyond the shave plane corresponds to a cleaning position of the spacer.

9. The razor blade cartridge as claimed in claim 1, further comprising a locking mechanism selectively locking the spacer in the plurality of the working positions.
